(19) United States
(12) Patent Application Publication
(10) Pub. No.: US 2020/0249777 A1
(43) Pub. Date: Aug. 6, 2020

(54) OPTICAL TOUCH PANEL AND PRESSURE MEASUREMENT METHOD THEREOF

(71) Applicant: Wistron Corporation, New Taipei City (TW)

(72) Inventors: Chia-Chang Hou, New Taipei City (TW); Po-Liang Huang, New Taipei City (TW)

(73) Assignee: Wistron Corporation, New Taipei City (TW)

(21) Appl. No.: 16/380,976

(22) Filed: Apr. 10, 2019

(30) Foreign Application Priority Data
Feb. 1, 2019 (TW) 108104123

(51) Int. Cl. G06F 3/042; G06F 3/041

(52) U.S. Cl. CPC G06F 3/042; G06F 2203/04105; G06F 3/04146

(57) ABSTRACT

An optical touch panel and a pressure measurement method thereof adapted to sense a touch input from a user are provided. The pressure measurement method includes: storing a deformation information table in the optical touch panel; emitting a first light beam from a first corner of the optical touch panel; emitting a second light beam from a second corner of the optical touch panel; sensing the first light beam and the second light beam to generate a sensing result; and determining pressure information of the touch input according to the sensing result and the deformation information table.

### CROSS-REFERENCE TO RELATED APPLICATION

This application claims the priority benefit of Taiwan application serial no. 108104123, filed on Feb. 1, 2019. The entirety of the above-mentioned patent application is hereby incorporated by reference herein and made a part of this specification.

### BACKGROUND

### Technical Field

The disclosure is a technique related to a display device, and in particular, to an optical touch panel and a pressure measurement method thereof.

### Description of Related Art

The optical touch panel detects coordinates of a touch point touched by the user through the light source module and the optical sensor disposed on the surface of the panel. For large-size panels, using the optical touch technique is more cost effective than using the resistive touch technique or capacitive touch technique. However, optical touch panels still have some disadvantages. For example, the current optical touch panel cannot detect the pressure applied by the user to the touch panel. If the optical touch technique is applied to the drawing tablet, the drawing tablet will need to be additionally provided with a pressure detector to measure the difference between a light stroke and a heavy stroke. As such, the manufacturing cost of the touch panel will increase.

### SUMMARY

In view of the above, the disclosure provides an optical touch panel and a pressure measurement method thereof that can measure a pressure by simply using the optical touch technique.

The disclosure provides an optical touch panel adapted to sense a touch input from a user. The optical touch panel includes a substrate, a frame, a first light source module, a second light source module, an optical sensor, a processor, and a storage unit. The first light source module is disposed at a first corner of the frame and generates a first light beam. The second light source module is disposed at a second corner of the frame and generates a second light beam. The optical sensor is disposed at a first edge of the frame and senses the first light beam and the second light beam to generate a sensing result. The storage unit stores a deformation information table of the substrate. The processor is coupled to the first light source module, the second light source module, the optical sensor, and the storage unit. The processor determines pressure information of the touch input according to the sensing result and the deformation information table.

The disclosure provides a pressure measurement method adapted to sense a touch input from a user. The pressure measurement method includes the following steps. A deformation information table is stored in an optical touch panel. A first light beam is emitted from a first corner of the optical touch panel. A second light beam is emitted from a second corner of the optical touch panel. The first light beam and the second light beam are sensed to generate a sensing result. Pressure information of the touch input is determined according to the sensing result and the deformation information table.

Based on the above, the optical touch panel of the disclosure can store the deformation information table of the substrate in advance. After detecting the position of the touch input of the user on the substrate by using the optical touch technique, the optical touch panel can determine the pressure information corresponding to the touch input through the lookup table method.

To make the aforementioned more comprehensible, several embodiments accompanied with drawings are described in detail as follows.

### BRIEF DESCRIPTION OF THE DRAWINGS

FIG. 1 is a schematic diagram showing an optical touch panel according to an embodiment of the disclosure.

FIG. 2 is a schematic diagram showing a substrate according to an embodiment of the disclosure.

FIG. 3A shows waveform diagrams of the deformation signal corresponding to a 1 unit pressure and a sensing block according to an embodiment of the disclosure.

FIG. 3B shows waveform diagrams of the deformation signal corresponding to a 1 unit pressure and another sensing block according to an embodiment of the disclosure.

FIG. 3C shows waveform diagrams of the deformation signal corresponding to a 1 unit pressure and still another sensing block according to an embodiment of the disclosure.

FIG. 4 is a schematic diagram showing another substrate according to an embodiment of the disclosure.

FIG. 5 is a flowchart showing a pressure measurement method according to an embodiment of the disclosure.

### DESCRIPTION OF THE EMBODIMENTS

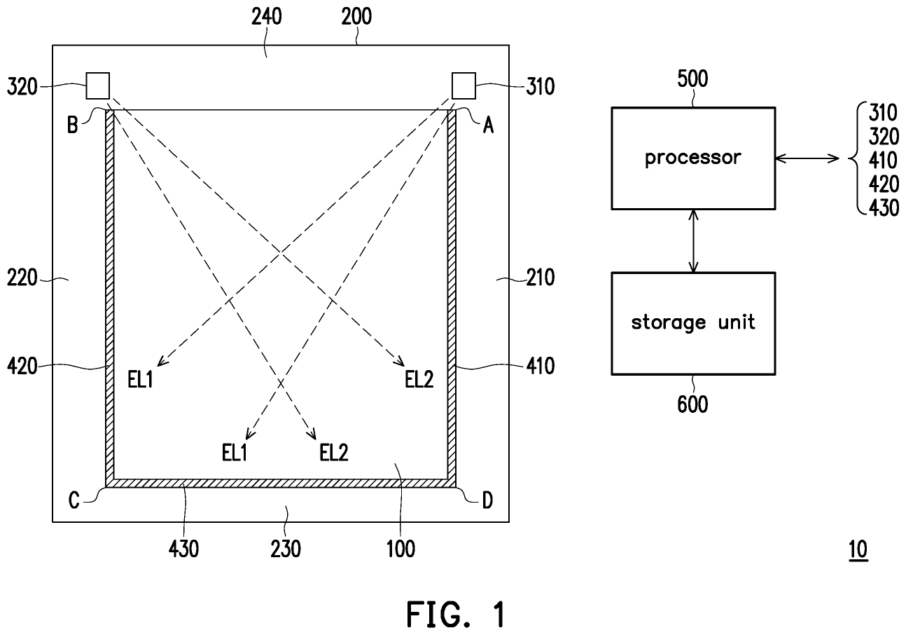

FIG. 1 is a schematic diagram showing an optical touch panel 10 according to an embodiment of the disclosure. The optical touch panel 10 includes a substrate 100, a frame 200, a first light source module 310, a second light source module 320, an optical sensor 410, a processor 500, and a storage unit 600. In some embodiments, the optical touch panel 10 further includes an optical sensor 420 and an optical sensor 430.

The substrate 100 covers the surface of the optical touch panel 10 and is, for example, a transparent thin plate. The material of the substrate 100 is, for example, glass, a plastic base material, or a polycarbonate film, but the disclosure is not limited thereto. When the user touches the substrate 100, the optical touch panel 10 senses a touch input corresponding to the user. The frame 200 is disposed around the substrate 100, and its material is, for example, a metal or plastic base material, but the disclosure is not limited thereto. The frame 200 has a first edge 210, a second edge 220, a third edge 230, and a fourth edge 240.

The first light source module 310 and the second light source module 320 are respectively disposed at a first corner A and a second corner B of the frame 200. The first light source module 310 is used to generate a first light beam EL1, and the second light source module 320 is used to generate a second light beam EL2. The first light source module 310 and the second light source module 320 are, for example, infrared emitters or laser emitters.

The optical sensor 410 is disposed at the first edge 210 of the frame 200. The optical sensor 410 senses the first light beam EL1 and the second light beam EL2 to generate a sensing result. When the user touches the substrate 100, the optical sensor 410 can sense the shadow caused by the user according to the first light beam EL1 and the second light beam EL2 to thereby detect the position of the substrate 100 touched by the user through the triangulation method. In the same manner, the optical sensor 420 disposed at the second edge 220 of the frame 200 senses the first light beam EL1 and the second light beam EL2 to generate a sensing result corresponding to the optical sensor 420, and the optical sensor 430 disposed at the third edge 230 of the frame 200 senses the first light beam EL1 and the second light beam EL2 to generate a sensing result corresponding to the optical sensor 430. In the present embodiment, the optical sensors 410, 420, and 430 are in a bar shape, but the disclosure is not limited thereto.

It is noted that the numbers and configuration positions of the light source modules and the optical sensors may be adjusted by the user according to the design requirements, and the disclosure is not limited thereto. For example, in some embodiments, the optical touch panel 10 may further include a light source module disposed at a corner C of the frame 200 and a light source module disposed at a corner D of the frame 200. In some embodiments, the optical touch panel 10 may further include an optical sensor disposed at the fourth edge 240 of the frame 200.

The storage unit 600 is, for example, a fixed or movable random access memory (RAM), read-only memory (ROM), flash memory, hard disk drive (HDD), solid state drive (SSD) in any form, a similar device, or a combination of the above devices. In the present embodiment, the storage unit 600 stores a deformation information table corresponding to the substrate 100.

The processor 500 is, for example, a central processing unit (CPU), another programmable microprocessor, digital signal processor (DSP), programmable controller, application specific integrated circuit (ASIC), graphics processing unit (GPU) for general or specific purposes, another similar device, or a combination of the above devices. In the present embodiment, the processor 500 is coupled to the first light source module 310, the second light source module 320, the optical sensor 410, the optical sensor 420, the optical sensor 430, and the storage unit 600.

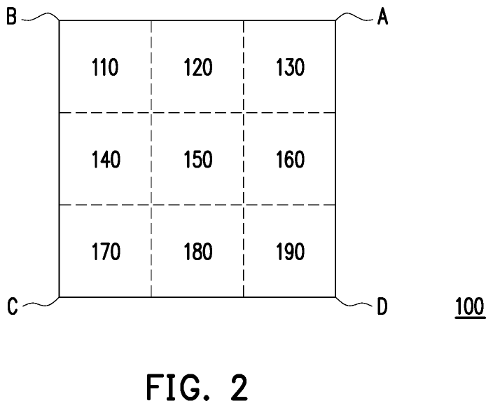

The deformation information table stores deformation information associated with different positions of the substrate 100. Taking FIG. 2 as an example, FIG. 2 is a schematic diagram showing the substrate 100 according to an embodiment of the disclosure. The substrate 100 is divided into a 3×3 matrix by virtual line segments, and the matrix includes sensing blocks 110, 120, 130, 140, 150, 160, 170, 180, and 190. Taking the sensing block 150 as an example, the deformation information table may store first deformation information of the sensing block 150, and the first deformation information records deformation values of the sensing block 150 under different pressures. In other words, the first deformation information includes a plurality of deformation values respectively corresponding to a plurality of pressures, as shown in Table 1.

TABLE 1

| Unit pressure | Deformation value |
|---|---|
| 0.25 | Deformation value 1 |
| 0.5 | Deformation value 2 |
| 1 | Deformation value 3 |
| 1.5 | Deformation value 4 |
| . . . | . . . |

Similarly, the deformation information table also stores a plurality of pieces of deformation information respectively corresponding to the sensing blocks 110, 120, 130, 140, 160, 170, 180, and 190, and each piece of the deformation information includes a plurality of deformation values respectively corresponding to a plurality of pressures.

The plurality of deformation values in Table 1 are associated with the optical sensor 410 or the optical sensor 420. Taking the case where the plurality of deformation values in Table 1 are associated with both the optical sensor 410 and the optical sensor 420 as an example, the deformation value of the sensing block 150 may be calculated according to the waveform diagram corresponding to the deformation signal of the sensing block 150. The deformation value corresponding to the optical sensor 410 and the sensing block 150 may be obtained according to Formula (1) shown below.

FV(x)=|Y2(x)−Y1|+|Y4(x)−Y3| Formula (1)

where FV is the deformation value; x is the pressure corresponding to the deformation value FV; Y1 is the mean value of the signal strength of the deformation signal generated by the optical sensor 410 when the sensing block 150 has not been touched; Y2 is the mean value of the signal strength of the deformation signal generated by the optical sensor 410 when the sensing block 150 is subjected to the pressure x; Y3 is the mean value of the signal strength of the deformation signal generated by the optical sensor 420 when the sensing block 150 has not been touched; and Y4 is the mean value of the signal strength of the deformation signal generated by the optical sensor 420 when the sensing block 150 is subjected to the pressure x.

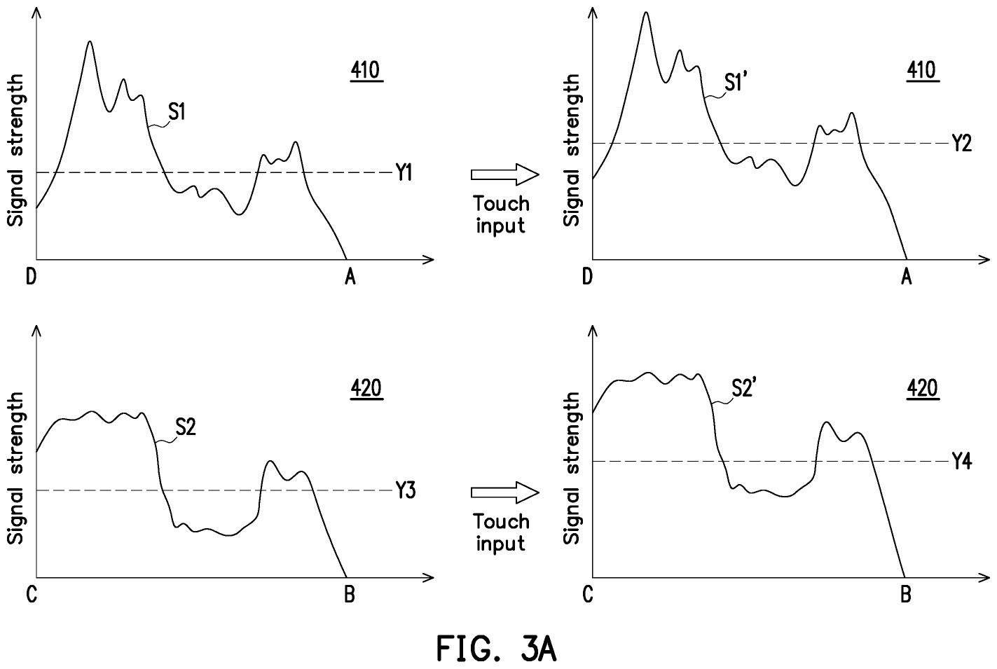

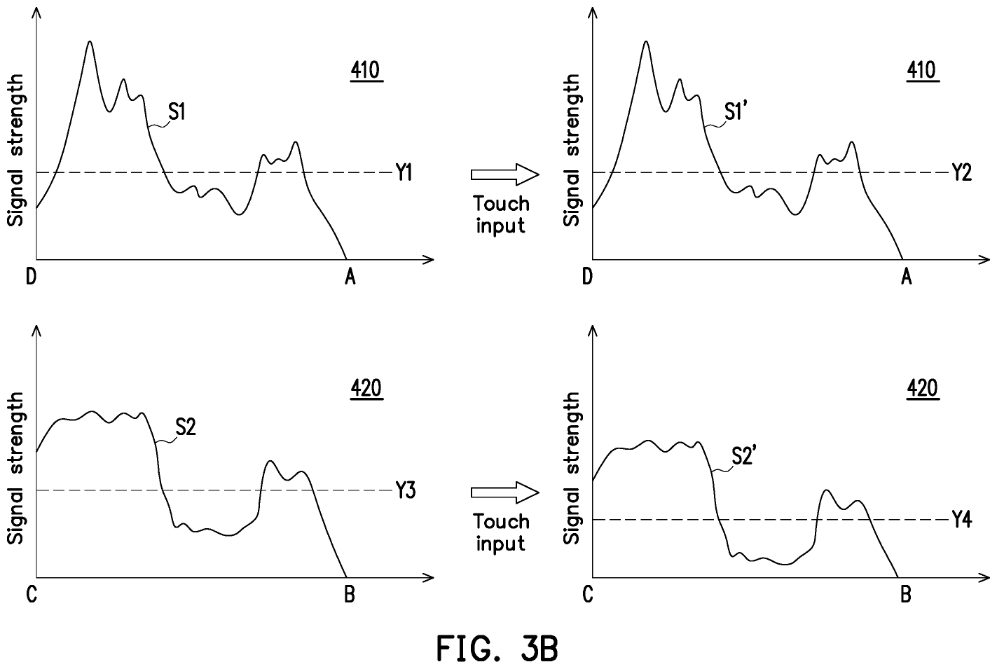

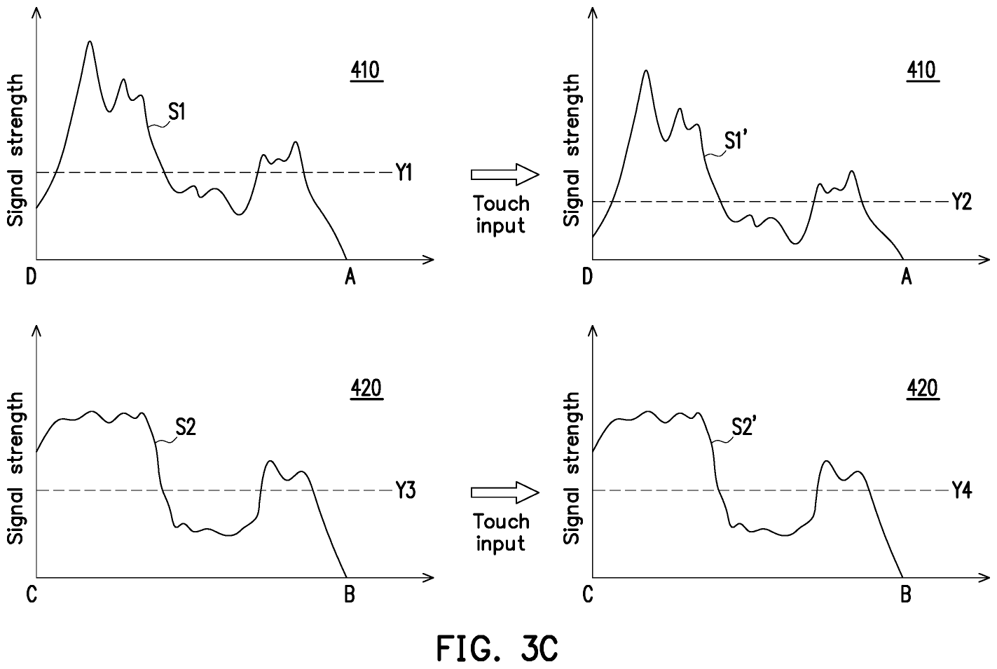

Taking FIG. 3A as an example, FIG. 3A shows waveform diagrams of the deformation signal corresponding to a 1 unit pressure and the sensing block 150 according to an embodiment of the disclosure. When the substrate 100 has not been touched, the optical sensor 410 can receive the complete first light beam EL1 and the complete second light beam EL2 and generate a deformation signal S1 of which the signal strength has a mean value of Y1. On the other hand, the optical sensor 420 can receive the complete first light beam EL1 and the complete second light beam EL2 and generate a deformation signal S2 of which the signal strength has a mean value of Y3.

After a 1 unit pressure is applied to the sensing block 150, the deformation signal S1 generated by the optical sensor 410 is changed to a deformation signal S1′ of which the signal strength has a mean value of Y2. On the other hand, the deformation signal S2 generated by the optical sensor 420 is changed to a deformation signal S2′ of which the signal strength has a mean value of Y4. In this case, Y2 is greater than Y1 and Y4 is greater than Y3. Accordingly, the deformation value 3 as shown in Table 1 may be calculated according to the formula, as shown below.

Deformation value 3=|Y2−Y1|+|Y4−Y3|

Then, 0.25, 0.5, 1.5, etc. unit pressures may be applied to the sensing block 150 to calculate the complete Table 1.

The deformation information table may further store the deformation information of the sensing block 130, as shown in Table 2.

TABLE 2

| Unit pressure | Deformation value |
|---|---|
| 0.25 | Deformation value 5 |
| 0.5 | Deformation value 6 |
| 1 | Deformation value 7 |
| 1.5 | Deformation value 8 |
| . . . | . . . |

Taking FIG. 3B as an example, FIG. 3B shows waveform diagrams of the deformation signal corresponding to a 1 unit pressure and another sensing block 130 according to an embodiment of the disclosure. When the substrate 100 has not been touched, the optical sensor 410 can generate a deformation signal S1 of which the signal strength has a mean value of Y1. On the other hand, the optical sensor 420 can generate a deformation signal S2 of which the signal strength has a mean value of Y3.

After a 1 unit pressure is applied to the sensing block 130, the deformation signal S1 generated by the optical sensor 410 is changed to a deformation signal S1′ of which the signal strength has a mean value of Y2. On the other hand, the deformation signal S2 generated by the optical sensor 420 is changed to a deformation signal S2′ of which the signal strength has a mean value of Y4. In this case, Y2 is approximately equal to Y1, and Y4 is smaller than Y3. Accordingly, the deformation value 7 as shown in Table 2 may be calculated according to Formula (1), as shown below.

Deformation value 7=|Y2−Y1|+|Y4−Y3

Then, 0.25, 0.5, 1.5, etc. unit pressures may be applied to the sensing block 130 to calculate the complete Table 2.

The deformation information table may further store the deformation information of the sensing block 170, as shown in Table 3.

TABLE 3

| Unit pressure | Deformation value |
|---|---|
| 0.25 | Deformation value 9 |
| 0.5 | Deformation value 10 |
| 1 | Deformation value 11 |
| 1.5 | Deformation value 12 |
| . . . | . . . |

Taking FIG. 3C as an example, FIG. 3C shows waveform diagrams of the deformation signal corresponding to a 1 unit pressure and still another sensing block 170 according to an embodiment of the disclosure. When the substrate 100 has not been touched, the optical sensor 410 can generate a deformation signal S1 of which the signal strength has a mean value of Y1. On the other hand, the optical sensor 420 can generate a deformation signal S2 of which the signal strength has a mean value of Y3.

After a 1 unit pressure is applied to the sensing block 170, the deformation signal S1 generated by the optical sensor 410 is changed to a deformation signal S1′ of which the signal strength has a mean value of Y2. On the other hand, the deformation signal S2 generated by the optical sensor 420 is changed to a deformation signal S2′ of which the signal strength has a mean value of Y4. In this case, Y2 is smaller than Y1, and Y4 is approximately equal to Y3. Accordingly, the deformation value 11 as shown in Table 3 may be calculated according to Formula (1), as shown below.

Deformation value 11=|Y2−Y1|+Y4−Y3|

Then, 0.25, 0.5, 1.5, etc. unit pressures may be applied to the sensing block 170 to calculate the complete Table 3.

The processor 500 is used to determine the pressure information of the touch input generated by the user on the substrate 100 according to the sensing result of the optical sensor (e.g., the optical sensor 410 or the optical sensor 420) and the deformation information table stored in the storage unit 600. Specifically, when the user touches the substrate 100 to generate a touch input, the processor 500 may determine the position of the substrate 100 at which the touch occurs according to the touch input. For example, the processor 500 may determine that the touch occurs on the sensing block 150 of the substrate 100 as shown in FIG. 2 according to the touch input. After determining that the touch has occurred on the sensing block 150, the processor 500 may look up a plurality of deformation values (as shown in Table 1) corresponding to the sensing block 150 in the deformation information table and determine the pressure information of the touch input according to a comparison result between the sensing result generated by the optical sensor 410 and the optical sensor 420 and each of the deformation values. More specifically, the processor 500 may calculate a deformation value corresponding to the touch input according to the sensing result and Formula (1). If the deformation value corresponding to the touch input is equal to the deformation value 3 as shown in Table 1, it means that the touch generating the touch input has applied a 1 unit pressure to the substrate 100. Analogously, if the deformation value corresponding to the touch input is equal to the deformation value 4 as shown in Table 1, it means that the touch generating the touch input has applied a 1.5 unit pressure to the substrate 100.

In some embodiments, if a third pressure applied to the substrate 100 by a touch and a corresponding third deformation value are not recorded in the deformation information table, the user may calculate the third pressure through an interpolation method. The formula of the interpolation method is as shown in Formula (2) below.

$$f = 1 - \frac{( d 2 - N ) \cdot ( p 2 - p 1 )}{( d 2 - d 1 )} \qquad Formula ( 2 )$$

where f is the third pressure; N is the third deformation value; d2 is the deformation value in the deformation information table that is closest to and greater than the third deformation value N; d1 is the deformation value in the deformation information table that is closest to and smaller than the third deformation value N; p2 is the pressure corresponding to the deformation value d2; and P1 is the pressure corresponding to the deformation value d1.

Taking Table 1 as an example, it is assumed that the processor 500 calculates that a pressure M applied by a touch to the sensing block 150 of the substrate 100 generates a deformation value N (assuming that the deformation value N=8) according to Formula (1), and the deformation value N is between the deformation value 2 (assuming that the deformation value 2=6) and the deformation value 3 (assuming that the deformation value 3=9). Accordingly, through the interpolation method, the processor 500 may calculate the pressure M as a ⅚ unit pressure according to the deformation value 2, the deformation value 3, the 0.5 unit pressure, and the 1 unit pressure, as shown below.

$$M = 1 - \frac{( 9 - 8 ) \cdot ( 1 - 0.5 )}{( 9 - 6 )} = \frac{5}{6}$$

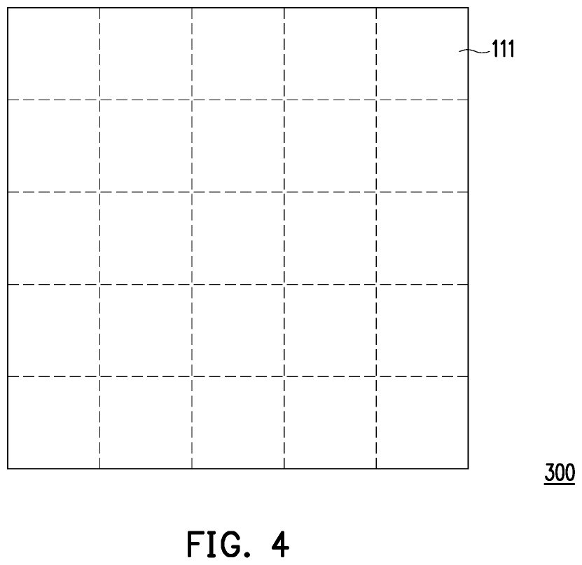

To improve the precision of the pressure information calculated by the processor 500, the number of the sensing blocks on the substrate may be increased to reduce the quantization step. However, increasing the number of the sensing blocks does not mean that it is necessary to measure deformation values in a new deformation information table. FIG. 4 is a schematic diagram showing another substrate 300 according to an embodiment of the disclosure. Referring to FIG. 2 and FIG. 4, it is assumed that a deformation information table records a plurality of deformation values corresponding to different pressure values corresponding to each of the sensing blocks 110, 120, 130, 140, 150, 160, 170, 180, and 190 of the substrate 100. In other words, the deformation information table corresponds to the case where the number of the sensing blocks is 3×3=9. It is assumed that the another substrate 300 has sensing block 111 in the number of 5×5=25, and the area of the sensing block 111 is different from the area of each of the sensing blocks 110, 120, 130, 140, 150, 160, 170, 180, and 190. In this case, the processor 500 may calculate a second deformation information table corresponding to the substrate 300 according to the existing deformation information table corresponding to the substrate 100 through the interpolation method. It is noted that the size of the substrate 300 may be the same as the size of the substrate 100 or different from the size of the substrate 100. Therefore, after generating a deformation information table, the processor 500 may calculate a new deformation information table applicable to an optical touch panel of various sizes based on the deformation information table through the interpolation method.

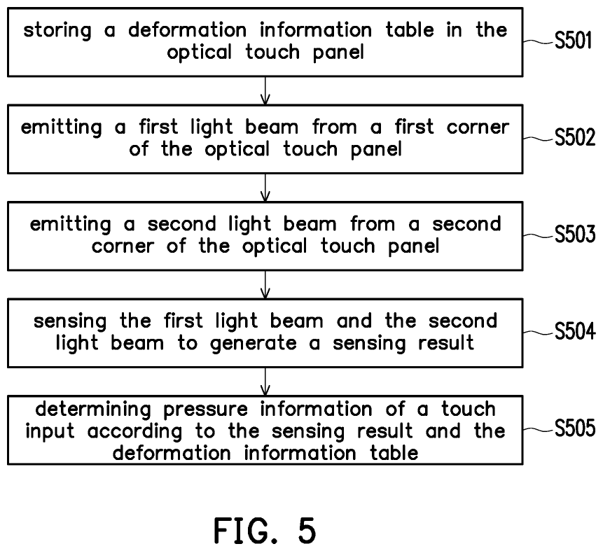

FIG. 5 is a flowchart showing a pressure measurement method according to an embodiment of the disclosure, and the pressure measurement method may be implemented by an optical touch panel 10. In step S501, a deformation information table is stored in the optical touch panel. In step S502, a first light beam is emitted from a first corner of the optical touch panel. In step S503, a second light beam is emitted from a second corner of the optical touch panel. In step S504, the first light beam and the second light beam are sensed to generate a sensing result. In step S505, pressure information of a touch input is determined according to the sensing result and the deformation information table.

In summary of the above, the optical touch panel of the disclosure can store the deformation information table of the substrate in advance. After detecting the position of the touch input of the user on the substrate by using the optical touch technique, the optical touch panel can determine the pressure information corresponding to the touch input through the lookup table method. In addition, the same deformation information table is also applicable to optical touch panels of different sizes. When the deformation information table is applied to an optical touch panel of a different size, the deformation information table may be converted into another deformation information table applicable to the optical touch panel of the different size through the interpolation method.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

1. An optical touch panel adapted to sense a touch input from a user, the optical touch panel comprising:
a substrate and a frame;
a first light source module, disposed at a first corner of the frame and generating a first light beam;
a second light source module, disposed at a second corner of the frame and generating a second light beam;
an optical sensor, disposed at a first edge of the frame, wherein the optical sensor senses the first light beam and the second light beam to generate a sensing result;
a storage unit, storing a deformation information table of the substrate; and
a processor, coupled to the first light source module, the second light source module, the optical sensor, and the storage unit, wherein the processor determines pressure information of the touch input according to the sensing result and the deformation information table,
wherein the deformation information table comprises first deformation information associated with a first sensing block on the substrate, wherein the first deformation information comprises a plurality of deformation values respectively corresponding to a plurality of pressures.

2. (canceled)

3. The optical touch panel according to claim 1, wherein the processor further determines that a position of the touch input corresponds to the first sensing block according to the sensing result, looks up the deformation values corresponding to the first sensing block in the deformation information table, and determines the pressure information of the touch input according to a comparison result between the sensing result and each of the deformation values.

4. The optical touch panel according to claim 1, wherein the deformation information table comprises a first deformation value of the first sensing block under a first pressure and a second deformation value of the first sensing block under a second pressure, and the processor calculates a third deformation value of the substrate under a third pressure according to the first deformation value and the second deformation value through an interpolation method, wherein the first pressure is greater than the third pressure, and the third pressure is greater than the second pressure.

5. The optical touch panel according to claim 1, wherein the deformation information table corresponds to the first sensing block having a first area, and the processor calculates a second deformation information table according to the deformation information table through an interpolation method, wherein the second deformation information table corresponds to a second sensing block having a second area, and the first area is different from the second area.

6. A pressure measurement method adapted to sense a touch input from a user, the pressure measurement method comprising:
storing a deformation information table in an optical touch panel;
emitting a first light beam from a first corner of the optical touch panel;
emitting a second light beam from a second corner of the optical touch panel;
sensing the first light beam and the second light beam to generate a sensing result; and
determining pressure information of the touch input according to the sensing result and the deformation information table,
wherein the deformation information table comprises first deformation information associated with a first sensing block on a substrate, wherein the first deformation information comprises a plurality of deformation values respectively corresponding to a plurality of pressures.

7. (canceled)

8. The pressure measurement method according to claim 6, further comprising:
determining that a position of the touch input corresponds to the first sensing block according to the sensing result;
looking up the deformation values corresponding to the first sensing block in the deformation information table; and
determining the pressure information of the touch input according to a comparison result between the sensing result and each of the deformation values.

9. The pressure measurement method according to claim 6, wherein the deformation information table comprises a first deformation value of the first sensing block under a first pressure and a second deformation value of the first sensing block under a second pressure, and the processor calculates a third deformation value of the substrate under a third pressure according to the first deformation value and the second deformation value through an interpolation method, wherein the first pressure is greater than the third pressure, and the third pressure is greater than the second pressure.

10. The pressure measurement method according to claim 6, wherein the deformation information table corresponds to the first sensing block having a first area, and the processor calculates a second deformation information table according to the deformation information table through an interpolation method, wherein the second deformation information table corresponds to a second sensing block having a second area, and the first area is different from the second area.
